(19) United States
(12) Patent Application Publication
(10) Pub. No.: US 2012/0024038 A1
(43) Pub. Date: Feb. 2, 2012

(54) METHOD FOR DETERMINING THE COEFFICIENT OF FRICTION IN A VEHICLE

(75) Inventors: Georg von Tardy-Tuch, Kapfenhardt (DE); Daniel Lunkeit, Leonberg (DE); Leonardo Pascali, Monsheim (DE)

(73) Assignee: Dr. Ing. h.c. F. Porsche Aktiengesellschaft, Stuttgart (DE)

(21) Appl. No.: 13/190,026

(22) Filed: Jul. 25, 2011

(30) Foreign Application Priority Data
Jul. 27, 2010 (DE) 102010036638.2

(51) Int. Cl. G01N 19/02

(52) U.S. Cl. 73/9

(57) ABSTRACT

A method and an arrangement for determining the coefficient of friction in a vehicle are proposed. In the method, the lateral guidance force at the at least one steered wheel is determined, wherein a steering rack force is sensed and a restoring torque at the steered wheel is determined as a function of the steering rack force and the lateral guidance force as a function of a caster, and the coefficient of friction is determined on the basis of the restoring torque.

### CROSS-REFERENCE TO RELATED APPLICATION

This U.S. patent application claims priority to German Patent Application DE 102010036638.2, filed on Jul. 27, 2010, which is incorporated by reference herein in its entirety.

### FIELD OF THE INVENTION

The invention relates to a method for determining the coefficient of friction in a vehicle and to an arrangement for carrying out the method.

### BACKGROUND OF THE INVENTION

The assessment of the current driving situation is significant, in particular, for electronic vehicle movement dynamics control systems such as, for example, ESP. For this it is necessary to determine the coefficient of static friction or the coefficient of friction between the vehicle or the wheels of the vehicle and the roadway.

Document DE 103 19 662 A1, which is incorporated by reference herein, describes a method for determining the coefficient of friction or coefficient of static friction in vehicles having at least one steered wheel on which a restoring torque acts during cornering. The document describes that the coefficient of friction is determined from the restoring torque which acts on the steered wheels during cornering. In this context, a current restoring torque can be determined from the signal of a steering torque sensor. The coefficient of friction is then determined from the current restoring torque and the vehicle movement dynamics values.

The document describes different possibilities for determining the coefficient of friction on the basis of the restoring torque. It is therefore possible to determine the latter using a processor device to which the restoring torque and the current vehicle movement dynamics variables are fed as input variables. Alternatively, the coefficient of friction can be determined indirectly from the current restoring torque and the vehicle movement dynamics variables. In a further described possibility, the coefficient of friction is determined using a device for experimental system identification, to which the current restoring torque and the vehicle movement dynamics values are fed as input variables. Vehicle movement dynamics variables are, for example, the longitudinal speed of a vehicle, the bend radius, the yaw speed and the lateral acceleration.

### SUMMARY OF THE INVENTION

An object of the present invention is to propose a method and an arrangement with which the coefficient of friction can be determined or detected even in uncritical driving states.

This object is achieved according to aspects of the invention with a method for determining the coefficient of friction in a vehicle having at least one steered wheel, in which the lateral guidance force at the at least one steered wheel is determined, wherein a steering rack force (Fzs) is sensed and a restoring torque (Mz) at the steered wheel is determined as a function of the steering rack force (Fzs) and the lateral guidance force as a function of a caster (t), and the coefficient of friction (μ) is determined on the basis of the restoring torque (Mz). and with an arrangement for determining the coefficient of friction in a vehicle having at least one steered wheel with a first device for determining the lateral guidance force at the steered wheel and a second device for sensing a steering rack force (Fzs) as well as a computing device with which a restoring torque (Mz) can be determined at the steered wheel as a function of the steering rack force (Fzs) and the lateral guidance force as a function of a caster (t), and the coefficient of friction (μ) can be determined on the basis of the restoring torque (Mz). Developments of the invention can be found in the dependent claims.

A method is therefore provided for determining the coefficient of friction in a vehicle having at least one steered wheel in which the lateral guidance force is determined at the at least one steered wheel, wherein a steering rack force is sensed and a restoring torque is determined at the steered wheel as a function of the steering rack force and the lateral guidance force as a function of a caster. The coefficient of friction is determined on the basis of the restoring torque.

The arrangement which is also proposed serves to determine the coefficient of friction in a vehicle having at least one steered wheel and is designed, in particular, to carry out the method described above. The arrangement has a first device for determining the lateral guidance force at the steered wheel and a second device for sensing a steering rack force. Furthermore, a computing device is provided with which a restoring torque can be determined at the steered wheel on the basis of the steering rack force and the lateral guidance force and as a function of a caster. The coefficient of friction can be determined on the basis of the restoring torque.

In order to detect a coefficient of friction in uncritical driving states, lateral guidance forces are determined at the front axle and the rear axle as a function of the measured lateral acceleration and yaw acceleration. By means of knowledge of the lateral acceleration and the yaw rate in the vehicle it is therefore possible to determine reliably the lateral guidance forces at the front axle and rear axle. The following applies:

Fyv+Fyh=M*ay

Fyv*a+Fyh*b=J*w_{—}p,

where Fyv, Fyh are the lateral guidance forces at the front axle and the rear axle. M represents the vehicle mass and 3 the moment of inertia of the vehicle. ay is the measured lateral acceleration and w_p is the yaw acceleration. Constants a and b are the respective distances between the front axle and the rear axle of the center of gravity of the vehicle as a whole.

The lateral guidance force at the front axle and the restoring torque are in a functional relationship with the steering rack force of the steering system via the axle kinematics.

Fzs=f(Fyv, Mz)

Here, Fzs is the steering rack force and Mz is the entire restoring torque.

The steering rack force can be determined by means of a corresponding state observer or by direct or indirect measurement. This can be carried out by measuring the assistance force at the counterbearing of the ball screw drive of an electric-mechanical power steering system, for example of an APA-EPS steering system. The steering rack force Fzs is available in real time from the equilibrium of forces.

Fzs=FH+FUE−Freib.

FH here is the force applied by the driver via the steering column pinion. Said force can be calculated from the manual torque measured at the torsion bar, using the pinion/steering rack transmission ratio.

The steering rack force is dependent on the force which is applied by the driver via the steering column pinion and which can be calculated from the manual torque measured at the torsion bar, by means of the pinion/steering rack transmission ratio. The friction of the steering gear mechanism can be estimated here. The assistance force at the counterbearing of the ball screw drive can be measured. The restoring torque can be determined as a function of the steering rack force and the lateral guidance force at the front axle as a function of the caster.

Freib represents the friction of the steering gear mechanism which can be satisfactorily to estimated. FUE is the assistance force measured at the counterbearing of the ball screw drive. Through knowledge of measuring Fzs and Fyv it is possible to calculate the restoring torque.

The restoring torque Mz is a function of the caster t here and can be formulated as:

Mz=Fyv*t=Fyv*(t+tp).

The caster t is composed of the mechanical caster tm and the pneumatic caster tp. In this context, the mechanical caster is given by the kinematics of the wheel suspension system and is therefore known. The friction-dependent pneumatic caster can be described essentially by a function of the coefficient of friction μ. Given an identical lateral acceleration, the necessary lateral guidance force remains the same. The proportion of torque which occurs as a result of the load distribution between the left-hand and right-hand tracks in the case of a specific lateral acceleration does not change either. A change in the restoring torque is therefore due to a coefficient-of-friction-dependent change in the pneumatic caster. This relationship can be identified from driving trials.

The coefficient of friction is known as a result of this functional relationship.

It is to be noted that in uncritical vehicle states, the manual torque which is to be applied by the driver increases as the lateral acceleration rises. At the junction between an uncritical driving state and a critical driving state, for example in the case of oversteering, the steering rack force requirement, and therefore the manual torque, collapses. A gradient comparison between the lateral acceleration and the steering rack force provides in this way the possibility of identifying critical driving states. Given identical signs of the gradients, the vehicle is in the stable region of the vehicle movement dynamics, and given different signs an unstable and therefore critical state is present.

### BRIEF DESCRIPTION OF THE DRAWINGS

Further advantages and refinements of the invention can be found in the description and the appended drawing.

It goes without saying that the features which are specified above and are to be explained below can be used not only in the respectively specified combination but also in other combinations or alone without departing from the scope of the present invention.

FIG. 1 is a schematic illustration of a steering system which is provided with an embodiment of the described arrangement for determining the coefficient of friction.

FIG. 2 is a schematic view of the way of executing the method for determining the coefficient of friction.

### DETAILED DESCRIPTION OF THE DRAWINGS

The invention is illustrated schematically in the Figures on the basis of embodiments and will be described with reference to the Figures.

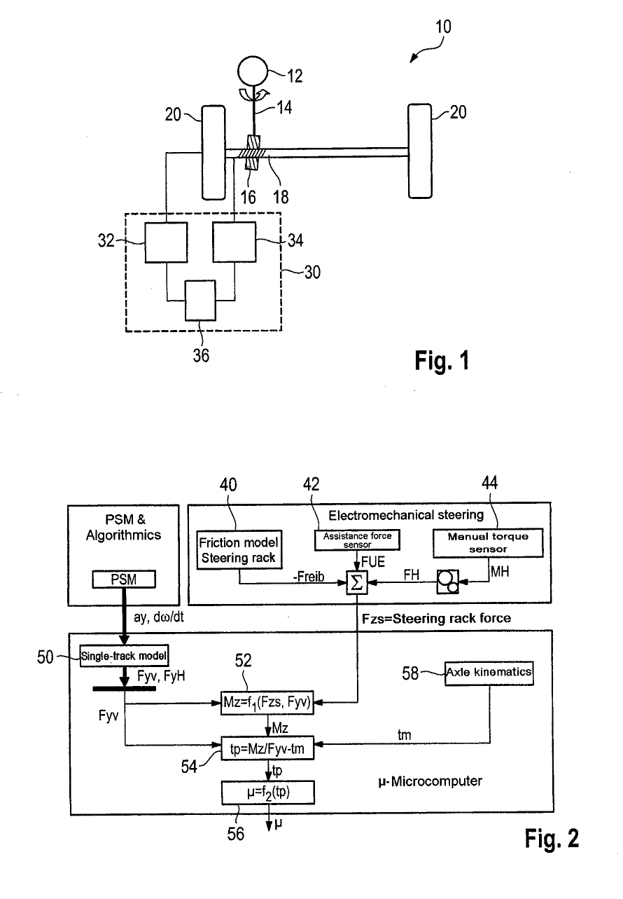

FIG. 1 illustrates a steering system, denoted overall by the reference number 10. This steering system 10 comprises a steering wheel 12, a steering column 14, a steering pinion 16, a steering rack 18 and steered wheels 20.

The wheels 20 engage on the steering rack 18 via steering tie rods (not shown). By means of the steering wheel 12, the driver applies a manual torque which is transmitted to the steering rack 18 via the steering column 14 and the steering pinion 16. The steering column 14 can be a mechanical, hydraulic or electric steering column.

An arrangement 30 is also illustrated which serves to determine the coefficient of friction at the left-hand, steered wheel 20. For this purpose, the arrangement 30 comprises a first device 32 for determining the lateral guidance force at the wheel 20, and a second device 34 for sensing the steering rack force. Furthermore, a computing device 36 is provided with which the restoring torque is determined as a function of the steering rack force and the lateral guidance force as a function of the caster, and the coefficient of friction is determined on the basis of the restoring torque. The lateral guidance force at the steered wheel 20 is determined here as a function of, or by means of knowledge of, the measured lateral acceleration and the yaw acceleration.

FIG. 2 illustrates the procedure in the described method for determining the coefficient of friction. The steering rack force Fzs is determined from a friction model 40 of the steering rack, an assistance force sensor 42 and a manual torque sensor 44 together. The steering rack force Fzs is therefore determined from the sum of the forces FH applied by the driver, the assistance force FUE measured at the counterbearing of the ball screw drive, minus the friction of the steering gear mechanism Freib, which can also be estimated.

The lateral guidance forces at the front axle Fyv and rear axle Fyh can also be determined by means of a single-track model 50. The lateral guidance force at the front axle Fyv together with the steering rack force are used by the latter in a step 52 to determine the restoring torque Mz. Use is made here of the fact that the lateral guidance force at the front axle Fyv and the restoring torque Mz are in a functional relationship by means of the axle kinematics 58.

Furthermore, the caster t, which is composed of the mechanical caster tm and the pneumatic caster tp, is also taken into account. The mechanical caster tm, which results from the kinematics of the wheel suspension system, is known. The pneumatic caster tp is determined in a further step 54.

The pneumatic caster tp can be described essentially by a function of the coefficient of friction, with the result that the coefficient of friction μ can be determined in a step 56.

1.-10. (canceled)

11. A method for determining the coefficient of friction in a vehicle having at least one steered wheel, in which the lateral guidance force at the at least one steered wheel is determined, wherein a steering rack force (Fzs) is sensed and a restoring torque (Mz) at the steered wheel is determined as a function of the steering rack force (Fzs) and the lateral guidance force as a function of a caster (t), and the coefficient of friction (μ) is determined on the basis of the restoring torque (Mz).

12. The method as claimed in claim 11, in which the steering rack force (Fzs) is determined by means of a state observer.

13. The method as claimed in claim 11, in which the steering rack force (Fzs) is determined by means of a direct measurement.

14. The method as claimed in claim 11, in which the steering rack force (Fzs) is determined by means of an indirect measurement.

15. The method as claimed in claim 11, in which the lateral guidance force is determined by means of knowledge of the lateral acceleration and the yaw acceleration.

16. The method as claimed in claim 11, in which a gradient comparison between the yaw acceleration and the steering rack force (Fzs) is carried out in order to detect a critical driving state.

17. The method as claimed in claim 11, in which a change in the restoring torque (Mz) is traced back to a functional relationship, specifically the coefficient-of-friction-dependent change in a pneumatic caster (tp), and this functional relationship is used to determine the coefficient of friction (μ).

18. The method as claimed in claim 11, in which the functional relationship is identified from driving trials.

19. An arrangement for determining the coefficient of friction in a vehicle having at least one steered wheel with a first device for determining the lateral guidance force at the steered wheel and a second device for sensing a steering rack force (Fzs) as well as a computing device with which a restoring torque (Mz) can be determined at the steered wheel as a function of the steering rack force (Fzs) and the lateral guidance force as a function of a caster (t), and the coefficient of friction (μ) can be determined on the basis of the restoring torque (Mz).

20. The arrangement as claimed in claim 19, in which the second device for determining a steering rack force (Fzs) is designed to measure an assistance force at a counterbearing of a ball screw drive.
